(19) United States
(12) Patent Application Publication
(10) Pub. No.: US 2007/0181000 A1
(43) Pub. Date: Aug. 9, 2007

(54) Air quality device

(75) Inventors: Mark Wayne Wilson, Simpsonville, KY (US); Mahendra Patil, Bangalore (IN); John Kenneth Hooker, Louisville, KY (US); Arti Shah, Maharashtra (IN); Carl Tobert Whitaker, LeGrange, KY (US); Sathi Bandaru, Andhra Pradesh (IN); Alexander Pinkus Rafalovich, Louisville, KY (US); Gautam Subbarao, Louisville, KY (US); Yefim Tsozik, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/346,811

(22) Filed: Feb. 3, 2006

(51) Int. Cl. B01D 53/02

(52) U.S. Cl. 96/134

(57) ABSTRACT

An air quality device includes a housing defining an airflow path, a humidity control module in flow communication with the airflow path, and an air contaminant removal module. The air contaminant removal module comprises at least one of a particle removal module arranged within the housing, an odor removal module arranged within the housing, and an anti-microbial module arranged within the housing.

### BACKGROUND OF THE INVENTION

This invention relates generally to air quality devices, and more particularly, to modular indoor air quality devices.

Known air treatment systems are utilized to provide purified clean air after dust, bacteria and contaminants in the air are removed. The systems remove airborne particles from the airflow through the air treatment system. Some known air treatment systems include a particle filter positioned within the air treatment system. Particles, such as dust or contaminants, are removed from the air flowing through the filter. These filters must be replaced at regular intervals. Some other known air treatment systems include an ionizer having an electrical charge to attract particles channeled through the ionizer. As such, the particles are removed from the airflow. These ionizers must be cleaned at regular intervals. At least some other known air treatment systems include an electronic or electrostatic filter that generally includes a plurality of horizontal partitions bearing a negative polarity. When positively charged dust particles flow between the horizontal partitions of the electrostatic filter, the dust particles are adsorbed and collected on the negatively charged horizontal partitions by electrostatic attraction.

Additionally, at least some air treatment systems include a humidifier to supply humid air to a home or building. These known humidifiers provide humid air which helps prevent some health issues and which provide a comfortable air supply to the home or building.

However, consumers typically purchase specific individual components to assemble an array of air treatment devices that are specific to the consumers air quality concerns. Generally, the individual devices are assembled onto the existing ducts in the building and are placed at a convenient location along the ducts. As such, the devices are in flow communication with one another to form the array of components. This array of components typically occupies a large area as the various components are attached to the ducts at various locations upstream and downstream of the furnace. Additionally, each individual component in the array functions independently from the other components increasing the difficulty of maintaining the overall air treatment system in the consumers home or building, and reducing the overall effectiveness of the air treatment system.

### BRIEF DESCRIPTION OF THE INVENTION

In one aspect, an air quality device is provided including a housing defining an airflow path, a humidity control module in flow communication with the airflow path, and an air contaminant removal module in flow communication with the airflow path. The air contaminant removal module comprises at least one of a particle removal module arranged within the housing, an odor removal module arranged within the housing, and an anti-microbial module arranged within the housing.

In another aspect, an air quality device is provided including a housing defining an airflow path, a humidity control module in flow communication with the airflow path, and an air contaminant removal module in flow communication with the airflow path. The air contaminant removal module comprises at least one of a particle removal module arranged within the housing, an odor removal module arranged within the housing, and an anti-microbial module arranged within the housing. The air quality device also includes a controller operatively coupled to each of the air containment removal modules and the humidity control module.

In another aspect, an air quality device is provided including a housing defining an airflow path, a humidity control module in flow communication with the airflow path, and an air contaminant removal module in flow communication with the airflow path. The air contaminant removal module comprises at least one of a particle removal module arranged within the housing, an odor removal module arranged within the housing, and an anti-microbial module arranged within the housing. The air quality device also includes an air moving device coupled in flow communication with the airflow path, and a controller operatively coupled to each of the air containment removal modules, the humidity control module, and the air moving device.

In yet another aspect, a method of purifying air is provided including providing a humidity control module, providing an air containment removal module comprising at least one of a particle removal module, an odor removal module, and an anti-microbial module, channeling airflow through the humidity control module, and channeling airflow through air containment removal module.

### BRIEF DESCRIPTION OF THE DRAWINGS

FIG. 1 is a perspective view of an exemplary air quality device;

FIG. 2 is a schematic view of the air quality device shown in FIG. 1 positioned with respect to a heating and cooling system in accordance with an exemplary embodiment of the present invention;

FIG. 3 is a schematic view of the air quality device shown in FIG. 1 in an alternative position with respect to the heating and cooling system;

FIG. 4 is a schematic view of the air quality device shown in FIG. 1 illustrating monitoring and control systems of the air quality device;

FIG. 5 is a fan state diagram; and

FIG. 6 is a schematic view of monitoring and control system of the air quality device shown in FIG. 1.

### DETAILED DESCRIPTION OF THE INVENTION

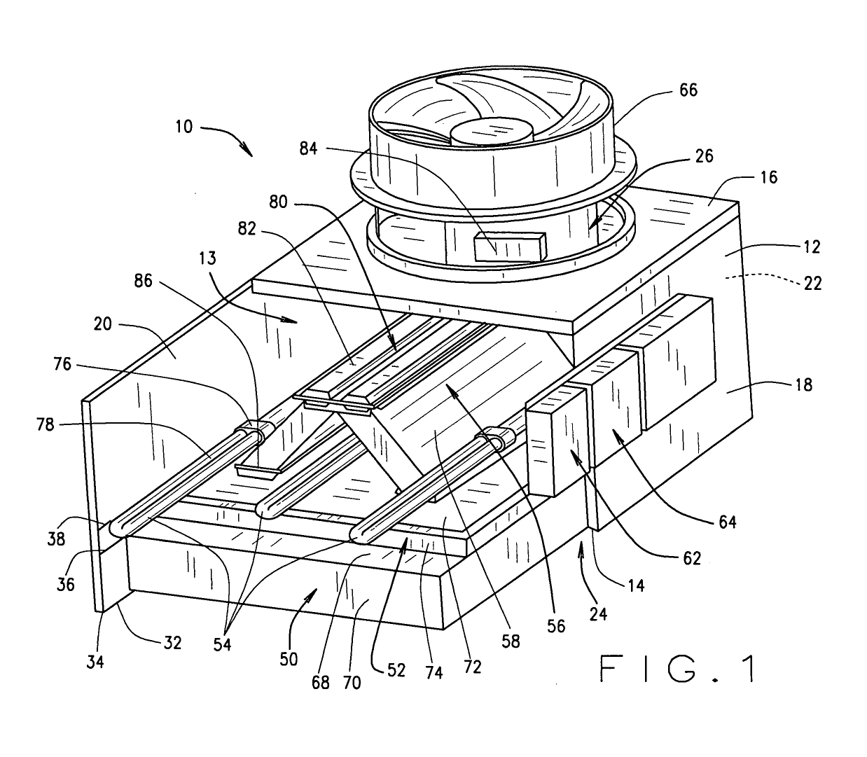

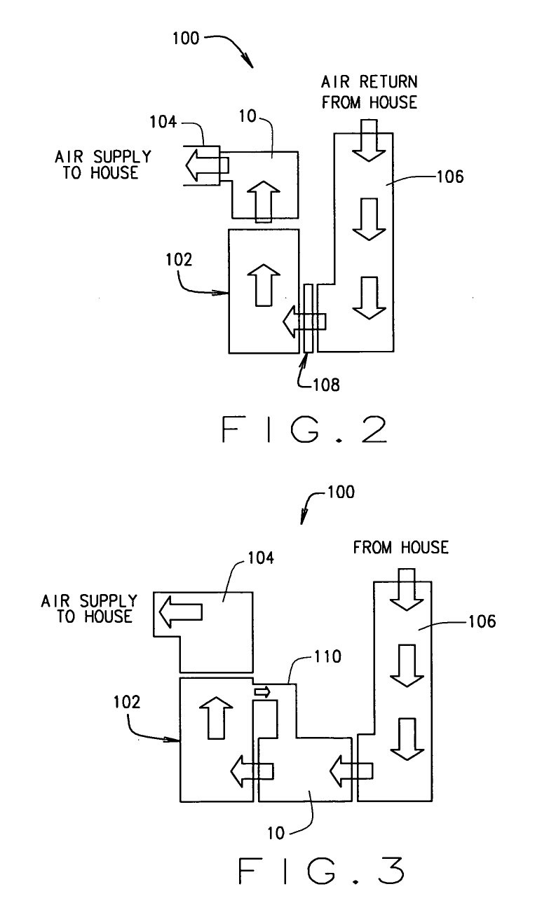

FIG. 1 is a perspective view of an exemplary air quality device 10. In the exemplary embodiment, air quality device 10 is an integrated air treatment system combining multiple modules for cleaning, purifying, and/or improving the quality of the airflow channeled therethrough. In one embodiment, air quality device 10 is utilized with a heating and cooling system or climate control system 100 (shown in FIG. 2) of a house or building for improving the indoor air quality in the house or building. The system may be a central system or an individual climate control unit, such as a window unit. Sources of poor indoor air quality include allergens, odorants, pathogens, low humidity and the like. By way of example, some allergens include dust mites, insect debris, pollen, mold and the like, which may lead to allergic reactions, asthma or other health and comfort problems. Odorants may include odors from pets or smoke, odors from outside the house or building, or other unpleasant smells. Pathogens may include bacteria and viruses, which may lead to illness or disease. Low humidity may lead to wood shrinkage, dry eyes or nasal passages, static charge, or other issues or irritants. Air quality device 10 is installed with respect to the heating and cooling system, such as in ductwork associated with the system, to reduce, and in some circumstances, eliminate the sources of poor indoor air quality. In one embodiment, air quality device 10 may be retrofit to an existing heating and cooling system. Specifically, air quality device 10 is coupled in flow communication with a duct system of the house or building. In an alternative embodiment, air quality device 10 is a stand-alone unit and may be positioned within a particular room of the house or building.

Air quality device 10 includes a housing 12 having a plurality of walls surrounding a central cavity 13. For example, housing 12 includes a lower wall 14, an upper wall 16, first and second side walls 18 and 20, respectively, a front wall 22, and a rear wall (not shown). Housing 12 may include more or less walls, and the orientation of the walls may differ depending on the mounting location of air quality device 10 with respect to the heating and cooling system. In the exemplary embodiment, housing 12 is fabricated from a durable material such as, but not limited to, a plastic material, such as ABS plastic, or a metal material.

In the exemplary embodiment, housing 12 includes an air inlet 24 extending through one of the walls, such as lower wall 14, and an air outlet 26 extending through another of the walls, such as upper wall 16. In one embodiment, substantially an entire portion of lower and upper walls 14 and 16 are open to define air inlet 24 and air outlets 26, respectively. However, in alternative embodiments, air inlet 24 and outlet 26 are arranged at other positions of housing 12, and housing 12 includes more or less inlets and/or outlets than shown in FIG. 1.

Housing 12 defines an airflow path between air inlet 24 and air outlet 26. A plurality of air quality improvement modules, as discussed below in more detail, are positioned along the airflow path for purifying and improving the quality of the air. Air inlet 24 allows an initial, contaminated airflow to be channeled into housing 12. Specifically, the airflow may be contaminated with airborne particles such as, but not limited to, allergens, particulates, microbes, bacteria, odors, and the like. The air quality improvement modules purify the air within housing 12. Air outlet 26 allows a purified airflow, having an improved air quality as compared to the initial airflow, to be discharged from housing 12.

In the exemplary embodiment, a plurality of ledges 32 protrude from an inner side of each side wall 18 and 20 to form a first lower guide rail 34, a second middle guide rail 36, and a third upper guide rail 38. However, more or less than three guide rails may be formed within housing 12. In the exemplary embodiment, guide rails 34, 36, and 38 support and/or retain air quality device components therein, such as, for example, filters, as will be described in detail below.

In the exemplary embodiment, received in housing 12 of air quality device 10 are a particle removal module 50, an odor removal module 52, an anti-microbial module 54, and a humidity control module 56 that includes both a humidifying component and a dehumidifying component. In one embodiment, air quality device 10 also includes a fragrance injector module 62 and an ozone generation module 64. In alternative embodiments, air quality device 10 may not include all of the above identified modules. In other alternative embodiments, air quality device 10 includes more than one of each module.

In the exemplary embodiment, air quality device 10 includes an air moving device or fan 66 coupled to housing 12. In one embodiment, air quality device 10 includes a plurality of fans configured to operate in series or in parallel with one another. Fan 66 facilitates channeling airflow from inlet 24 to outlet 26. Additionally, fan 66 may operate as a booster fan to increase an amount of airflow exhausted from device 10. Fan 66 may facilitate operating air quality device 10 independently of the heating and cooling system, or when the heating and cooling system is not operating. Alternatively, fan 66 facilitates supplying additional airflow through air quality device 10 when needed. In one embodiment, fan 66 is a variable speed fan capable of operating at multiple speeds. In the exemplary embodiment, fan 66 is coupled to air outlet 26. However, in alternative embodiments, fan 66 is coupled to air inlet 24 or within housing 12. In another alternative embodiment, fan 66 is coupled externally and is in flow communication with air quality device 10 via a duct (not shown).

Particle removal module 50 includes a particle filter element 68 having a filter media configured to remove airborne particles from the airflow channeled through filter element 68. Particle removal module 50 is configured to remove particulates, such as, dust, dander, pollen, bacteria, allergens, and other types of contaminants from the airflow channeled through housing 12. The filter media is fabricated from a fibrous material such as a plastic fiber, fiberglass, or the like and may have a woven or non-woven construction. A frame 70 receives particle filter element 68 and supports filter element 68 within first guide rail 34. In one embodiment, filter element 68 is positioned proximate air inlet 24 and is the first air quality improvement module. As such, particle removal module 50 removes particles from the airflow prior to channeling the airflow to the other various components of air quality device 10. In one embodiment, particle filter element 68 can be implemented with a HEPA (High-Efficiency Particle Air) filter. In alternative embodiments, particle filter module 50 may include other particle filter elements, such as, for example, an electrostatic plate or cell element, an electrostatic media filter element, an impingement filter element, a particle ionization element, or a wet humidification media element for filtering particles from the airflow through particle filter module 50. Additionally, multiple particle filtering elements may be used in particle removal module 50 to increase particle filtration efficiency, such as, for example, multiple sized filter elements, pre-filter elements, or post-filter elements.

Odor removal module 52 includes an activated carbon media filter element 72 having loose, granulated material arranged in a media filter fonnat. A frame 74 receives carbon media filter element 72 and is received within second guide rail 36. An activated alumina media element may also be used. As such, odor removal module 52 is positioned downstream of particle removal module 50. Odor removal module 52 removes undesired odors, such as, for example, cigarette odors, pet odors, human odors, food odors, and the like. In one embodiment, odor removal module 52 includes a chemical catalyst element in a filter form for converting the chemical properties of the odors in the air. As a result, the odors in the air are removed. The chemical catalysts include compounds such as, for example, potassium permanganate, calcium permanganate, sodium permanganate, and the like. In another embodiment, odor removal module 52 includes a photo-catalyst element which creates particles which eliminate odors when activated by ultra-violet light. For example, the odor removal module 52 includes surfaces coated with a compound such as a titanium dioxide. Odor removal module 52 may also include an ozone generating element, a hydroxyl radical generating element or an absorption filter element.

Anti-microbial module 54 includes lamp holders 76 and ultraviolet lamps 78 attached to lamp holders 76. In the exemplary embodiment, lamps 78 are bi-axial UV lamps. In other embodiments, lamp 78 includes a single UV lamp having a plurality of spaced apart parallel sections that serpentine through housing 12. Lamps 78 are positioned within housing 12 such that the airflow is exposed to the ultraviolet light emitted by lamps 78. In one embodiment, lamps 78 are positioned proximate the various other air quality device components for microbial growth retardation on the other air quality device components. In one embodiment, anti-microbial module 54 includes reflective devices (not shown) positioned proximate lamps 78 to increase the efficiency of anti-microbial module 54. Anti-microbial module 54 facilitates removing contaminants such as, for example, bacteria, viruses, microbes, mold, and the like, from the airflow channeled through housing 12. Generally, these types of contaminants are not removed by particle removal module 50, as these contaminants are relatively small in size. Additionally, these types of contaminants are living, and may be eliminated by exposure to ultraviolet light produced by lamps 78. In one embodiment, UV lamps 78 may be used to sterilize or remove contaminants from other modules or filters or media by exposing the contaminants to the UV light. In alternative embodiments, anti-microbial module 54 includes an ozone generation element or an ionization element for substantially reducing the number of microbial contaminants in the airflow.

Humidity control module 56 facilitates controlling the humidity of the airflow channeled through housing 12. In the exemplary embodiment, humidity control module 56 includes a plurality of humidifying element 58 each having a humidifying media therein. Humidification of the airflow is facilitated by evaporation of water contained within the humidifying media. To facilitate increasing an evaporation rate of the water, in one embodiment, the humidifying media is heated. For example, the humidifying media may be heated from heated furnace air or an auxiliary heating element (not shown) coupled to the humidifying media. In another embodiment, the water delivered to the humidifying media is heated. In an exemplary embodiment, the humidifying media includes fibrous materials such as, for example, fiberglass or cellulose. The fibrous material is divided into water channels and intersecting air channels. The channels intersect at either perpendicular or non-perpendicular angles. In one embodiment, the water channels are inclined and the air channels are substantially horizontal. The water channels may extend substantially parallel to the outer surfaces of the humidifying media or the water channels may extend at an oblique angle with respect to the outer surfaces. In another embodiment, the humidifying media includes an aluminum mesh or an aluminum plate. The humidifying media may include an anti-microbial agent, such as, for example, silver ions, to retard mold, mildew and bacteria growth.

Humidifying elements 58 are positioned within housing 12 and are in flow communication with the airflow in housing 12. In an exemplary embodiment, humidifying elements 58 are inclined with respect to the direction of airflow through housing 12. As such, an overall height of air quality device 10 is reduced. Additionally, humidifying elements 58 have an increased surface area for the air flowing therethrough. In alternative embodiments, humidifying elements 58 extend substantially horizontally or substantially vertically within housing 12. In another alternative embodiment, humidity control module 56 is positioned externally with respect to housing 12 and a portion of the airflow is bypassed from housing 12 to humidity control module 56. For example, a portion of the airflow from housing 12 may be directed to humidity control module 56 via a duct (not shown) extending therebetween, and then returned either to housing 12 or downstream of housing 12.

Humidity control module 56 includes a water supply system 80 having water supply elements 82 and valves (not shown) for controlling the supply of water to elements 82. In one embodiment, each element 82 is a water distribution tray configured to be filled with water and then drain to a corresponding humidifying element 58. The water distribution tray may be pressurized. The water distribution tray may be gravity assisted. In another embodiment, each element 82 is a water spray nozzle or water spray tube having a plurality of holes configured to spray water onto a corresponding humidifying element 58. In one embodiment, the water supplied to elements 82 is heated to facilitate enhancing the evaporation from humidifying elements 58. Water supply elements 82 may apply water to humidifying elements 58 uniformly. Water supply system 80 also includes a water filtration system 84 configured to facilitate preventing calcium and/or hard water buildup in water supply system 80 components, and increasing the useful life of humidity control module 56. Water filtration system 84 includes a filter element (not shown), such as, for example, a reverse osmosis filter or filtering media.

Humidity control module 56 also includes drain pans 86 positioned below humidifying elements 58 for catching excess water therefrom. In one embodiment, the water collected by drain pans 86 is re-circulated to water supply elements 82 via a re-circulation water tank (not shown). The water tank holds a predetermined amount of water. Water is supplied to the water tank by drain pans 86 and a fresh water supply. The water level in the water tank is maintained by a level sensor, such as, for example, a float valve, a sonic level sensor, or a pressure sensor. In one embodiment, the water tank and/or water supply system 80 is flushed to reduce saline buildup. The flushing may be facilitated by a drain or a pump with a drain line. The flushing occurs based on a predetermined lapse of time and/or a predetermined amount of mineral content within the water tank or water supply system 80.

Fragrance injector module 62 is positioned within housing 12 and facilitates supplying a pleasing fragrance to the airflow within housing 12. In the exemplary embodiment, fragrance injector module 62 is positioned proximate outlet 26.

Ozone generation module 64 is positioned within housing 12 and facilitates removing and/or eliminating contaminants such as, for example, odors or microbes from the channeled airflow. In the exemplary embodiment, ozone generation module 64 is positioned downstream of anti-microbial module 54.

FIG. 2 is a schematic view of air quality device 10 positioned with respect to a heating and cooling system or a climate control system 100, such as in the ductwork associated with system 100, downstream of a main air handler or unit 102. Air quality device 10 has a generally horizontal configuration, wherein the various components of air quality device 10 extend generally horizontally within housing 12. The airflow through air quality device 10 is substantially perpendicular to each of the air quality device components such that the airflow is generally vertical through housing 12.

Heating and cooling system 100 includes an air supply duct 104 and an air return duct 106 in flow communication with air handler 102. Air supply duct 104 supplies heated or cooled air from air handler 102 to the house or building. Return air is drawn through return duct 106 to air handler 102 through a pre-filter element 108.

As illustrated in FIG. 2, air quality device 10 is positioned within air supply duct 104, downstream of air handler 102. Air quality device 10 may be retro-fit to an existing heating and cooling system 100 of a house or building. In one embodiment, air inlet 24 is coupled directly to the outlet of air handler 102 and air outlet 26 is coupled to air supply duct 104. In another embodiment, air inlet 24 is coupled to air supply duct 104, and air outlet 26 is positioned adjacent a room vent such that the air form air quality device 10 is exhausted directly into the room. By positioning air quality device 10 downstream of air handler 102, microbes, odors and/or particles from heating and cooling system 100 are substantially eliminated and purified air is supplied to the house or home via air supply duct 104. Additionally, by positioning air quality device 10 downstream of air handler 102, the existing pre-filter 108 is utilized to remove at least some contaminants from the airflow prior to entering air quality device 10.

FIG. 3 is a schematic view of air quality device 10 positioned with respect to heating and cooling system 100, such as within the ductwork associated with system 100, upstream of air handler 102. Air quality device 10 has a generally vertical configuration, wherein the various components of air quality device 10 extend generally vertically within housing 12. The airflow through air quality device 10 is substantially perpendicular to each of the air quality device components such that the airflow is generally horizontal through housing 12.

As illustrated in FIG. 3, air quality device 10 is positioned within air return duct 106, upstream of air handler 102. As a result, air quality device 10 eliminates the need for the pre-filter 108 (shown in FIG. 2). In one embodiment, air inlet 24 is coupled to return duct 106 and air outlet 26 is coupled directly to the outlet of air handler 102. In another embodiment, air inlet 24 is positioned adjacent an air return vent such that the air is pulled directly from the area to be treated, and air outlet 26 is coupled to return duct 106. In one embodiment, a bypass duct 110 is provided for supplying heated airflow to air quality device 10 to facilitate increasing a humidification rate within air quality device 10.

FIG. 4 is a schematic view of air quality device 10 illustrating a monitoring and control system 120 of air quality device 10. In the exemplary embodiment, monitoring and control system 120 includes a plurality of sensors for determining an operating condition of air quality device 10. Additionally, monitoring and control system 120 includes a plurality of sensors for determining the quality of the airflow being channeled through air quality device 10. Monitoring and control system 120 also includes a controller 122 and a user interface 124. A user may monitor the operating condition and/or quality of airflow at the user interface 124. Additionally, the operation of air quality device 10 may be controlled by controller 122, as will be described in detail below.

Monitoring and control system 120 includes a particle removal module sensor 130 for monitoring the operating condition of and/or quality of airflow through particle removal module 50. In one embodiment, sensor 130 is positioned upstream of particle removal module 50. In another embodiment, sensor 130 is positioned downstream of particle removal module 50. In yet another embodiment, particle removal module sensors 130 are positioned both upstream and downstream of particle removal module 50. In one embodiment, sensor 130 is a pressure sensor configured to monitor the air pressure proximate particle removal module 50. For example, sensor 130 monitors a difference between an upstream and a downstream air pressure to determine an operating efficiency of particle removal module 50, or to measure a capacity or an amount of clogging of particle removal module 50. In another embodiment, sensor 130 is an air flow sensor configured to monitor a rate of flow or an amount of flow proximate particle removal module 50. For example, sensor 130 monitors a difference between an upstream and a downstream air flow to determine an operating efficiency of particle removal module 50, or to measure a capacity or an amount of clogging of particle removal module 50. In another embodiment, sensor 130 is a timer configured to measure an operating time of particle removal module 50. Sensor 130 is coupled to controller 122 and transmits a signal relating to the operating condition of and/or quality of airflow through particle removal module 50. As such, an operating mode of particle removal module 50, or other components of air quality device 10, may be changed based on a signal from sensor 130. Additionally, a maintenance schedule may be determined based on a signal from sensor 130. In alternative embodiments, other types of sensors may be utilized to monitor the operating condition of and/or quality of airflow through particle removal module 50.

Monitoring and control system 120 includes an odor removal module sensor 132 for monitoring the operating condition of and/or quality of airflow through odor removal module 52. In one embodiment, sensor 132 is positioned upstream of odor removal module 52. In another embodiment, sensor 132 is positioned downstream of odor removal module 52. In yet another embodiment, odor removal module sensors 132 are positioned both upstream and downstream of odor removal module 52. In one embodiment, sensor 132 is a pressure sensor configured to monitor the air pressure proximate odor removal module 52. For example, sensor 132 monitors a difference between an upstream and a downstream air pressure to determine an operating efficiency of odor removal module 52, or to measure a capacity or an amount of clogging of odor removal module 52. In another embodiment, sensor 132 is an air flow sensor configured to monitor a rate of flow or an amount of flow proximate odor removal module 52. For example, sensor 132 monitors a difference between an upstream and a downstream air flow to determine an operating efficiency of odor removal module 52, or to measure a capacity or an amount of clogging of odor removal module 52. In another embodiment, sensor 132 is a timer configured to measure an operating time of odor removal module 52. Sensor 132 is coupled to controller 122 and transmits a signal relating to the operating condition of and/or quality of airflow through odor removal module 52. As such, an operating mode of odor removal module 52, or other components of air quality device 10, may be changed based on a signal from sensor 132. Additionally, a maintenance schedule may be determined based on a signal from sensor 132. In alternative embodiments, other types of sensors may be utilized to monitor the operating condition of and/or quality of airflow through odor removal module 52.

Monitoring and control system 120 includes a water supply system sensor 134 and a water filtration system sensor 136. In one embodiment, water supply system sensor 134 is a humidity sensor and is configured to measure a humidity level of the airflow through air quality device 10. In another embodiment, water supply system sensor 134 measures a humidity level of air at a remote location with respect to air quality device 10, such as, for example, in supply duct 104 (shown in FIG. 2), in return duct 106 (shown in FIG. 2), in a room of the house or building, and the like. In yet another embodiment, water supply system sensor 134 is a media wetness sensor coupled to the humidifying media and is configured to measure the wetness of the media. For example, sensor 134 may be an electrical conductivity sensor configured to measure the wetness of the media, or sensor 134 may be a pressure sensor configured to determine pressure differential across the media to measure the wetness of the media. Sensor 134 is coupled to controller 122 and transmits a signal relating to the operating condition of and/or quality of airflow through humidity control module 56. As such, an operating mode of humidity control module 56, or other components of air quality device 10, may be changed based on a signal from sensor 132. Additionally, a maintenance schedule may be determined based on a signal from sensor 132. In alternative embodiments, other types of sensors may be utilized to monitor the operating condition of and/or quality of airflow through humidity control module 56.

In one embodiment, water supply system sensor 134 is coupled to water supply element 82 and/or the valve to measure an amount of water being supplied to humidity control module 56. In one embodiment, sensor 134 is a flow sensor, such as a ratemeter. Sensor 134 is coupled to controller 122 and transmits a signal relating to the amount of water supplied to humidity control module 56. As such, the water flow to humidity control module 56 may be restricted based on a signal from sensor 134.

Water filtration system sensor 136 is configured to monitor the operating condition of and/or quality of water supplied to water supply system 80. In one embodiment, sensor 136 is a pressure sensor configured to monitor the water pressure supplied to water supply system 80. For example, sensor 136 monitors a difference between an upstream and a downstream water pressure to determine an operating efficiency of water supply system 80, or to measure a capacity or an amount of clogging of a filter element. In another embodiment, sensor 136 is a flow sensor configured to monitor a rate of flow or an amount of flow through water filtration system 84. For example, sensor 136 monitors a difference between an upstream and a downstream water flow to determine an operating efficiency of water filtration system 84, or to measure a capacity or an amount of clogging of the filter elements. In another embodiment, sensor 136 is a timer configured to measure an operating time of water filtration system 84. Sensor 136 is coupled to controller 122 and transmits a signal relating to the operating condition of and/or quality of water flow through water filtration system 84. As such, an operating mode of water filtration system 84 may be changed based on a signal from sensor 136. Additionally, a maintenance schedule may be determined based on a signal from sensor 136. In alternative embodiments, other types of sensors may be utilized to monitor the operating condition of and/or quality of water flow through water filtration system 84.

Monitoring and control system 120 includes an anti-microbial module sensor 138 for monitoring the operating condition of and/or quality of airflow through anti-microbial module 54. In one embodiment, sensor 138 is an ultraviolet light sensor configured to detect an intensity of ultraviolet light from lamps 78 (shown in FIG. 1). For example, each UV lamp 78 may be pulsed to determine the operating condition of the individual lamp 78. Alternatively, each lamp 78 includes a corresponding sensor 138. In another embodiment, sensor 138 includes a current measuring sensor for monitoring an AC current of each lamp 78. In yet another embodiment, sensor 138 is a timer configured to measure an operating time of anti-microbial module 54. In a further embodiment, sensor 138 is configured to detect an amount of microbes downstream of anti-microbial module 54 to determine an effectiveness of anti-microbial module 54. Sensor 138 is coupled to controller 122 and transmits a signal relating to the operating condition of and/or quality of airflow through anti-microbial module 54. As such, an operating mode of anti-microbial module 54, or other components of air quality device 10, may be changed based on a signal from sensor 138. Additionally, a maintenance schedule may be determined based on a signal from sensor 138. In alternative embodiments, other types of sensors may be utilized to monitor the operating condition of and/or quality of airflow through anti-microbial module 54.

Monitoring and control system 120 includes a fragrance injection module sensor 140 for monitoring the operating condition of and/or quality of airflow through fragrance injector module 62. Monitoring and control system 120 includes an ozone generation module sensor 142 for monitoring the operating condition of and/or quality of airflow through ozone generation module 64.

Monitoring and control system 120 includes an air moving device sensor 144 for monitoring the operating condition of and/or quality of airflow through air quality device 10. In one embodiment, sensor 144 is a pressure sensor configured to monitor the air pressure proximate fan 66. For example, sensor 144 monitors a difference between an upstream and a downstream air pressure to determine a pressure drop within air quality device 10. In one embodiment, sensor 144 may be positioned remote with respect to air quality device, such as, for example, upstream and/or downstream of air quality device 10. As a result, sensor 144 determines a pressure differential of the air flowing through air quality device 10. When the pressure drop is above a predetermined amount, fan 66 is operated to increase the amount of airflow exhausted from air quality device 10. As such, fan 66 compensates for air pressure drop through air quality device 10 and facilitates providing a pressure differential of approximately zero. In another embodiment, sensor 144 is an air flow sensor, such as, for example, a flowmeter or a fan tachometer, configured to monitor a rate of flow or an amount of flow through air quality device 10. Sensor 144 is coupled to controller 122 and transmits a signal relating to the operating condition of and/or quality of airflow through air quality device 10. As such, an operating mode of fan 66 may be changed based on a signal from sensor 144. In alternative embodiments, other types of sensors may be utilized to monitor the amount of airflow through air quality device 10. Additionally, multiple fans 66 may be used.

FIG. 5 is a fan state diagram according to an exemplary operational state of fan 66. The fan state diagram is used in operating a multi-speed fan having, in the illustrated embodiment, four speeds, such as, for example, low speed, medium-low speed, medium-high speed, and high speed. However, depending on the particular application, fan 66 may have more or less than four speeds. Additionally, in an alternative embodiment, fan 66 may be a variable speed fan. The variable speed fan may be operated using a regulator, such as, for example, a proportional-plus-integral regulator (PI regulator) or a proportional-plus-integral-plus-derivative regulator (PID regulator). The regulator is coupled to the controller for controlling the operation of the variable speed fan. The regulator receives an input relating to a set-point, and also receives inputs or feedback relating to an error. The speed of the fan is controlled based on the set point and the error.

With reference to FIG. 5, fan 66 has a first state 202 wherein the main furnace or blower of heating and cooling system 100 (shown in FIG. 2) is in an off mode and fan 66 is in an off mode. When the main is turned on, a differential pressure across air quality device 10 (shown in FIG. 1) (DP1) is created. When DP1 is determined to be above a predetermined level, such as, for example, 0.2″, the fan state is changed to second state 204.

In second state 204, the main is in an on mode, fan 66 is in an off state, and a time delay is initiated for a predetermined amount of time. When DP1 is determined to be above a predetermined level, such as, for example, 0.4″, the fan state is changed to third state 206. However, at second state 204, if DP1 is determined to be below a predetermined level, such as, for example, 0.1″, the fan state is changed to first state 202.

In third state 206, the main is in an on mode, fan 66 is in an on state at a low speed, and a time delay is initiated for a predetermined amount of time. When DP1 is determined to be above a predetermined level, such as, for example, 0.4″, the fan state is changed to fourth state 208. However, at third state 206, if DP1 is determined to be below a predetermined level, such as, for example, 0.2″ but above 0.0″, the fan state is changed to second state 204. Additionally, if DP1 is determined to be below a predetermined level, such as, for example, 0.0″ such that a negative pressure is achieved such as when the main is in an off mode, the fan state is changed to a check filter state 210.

In fourth state 208, the main is in an on mode, fan 66 is in an on state at a medium-low speed, and a time delay is initiated for a predetermined amount of time. When DP1 is determined to be above a predetermined level, such as, for example, 0.4″, the fan state is changed to fifth state 212. However, at fourth state 208, if DP1 is determined to be below a predetermined level, such as, for example, 0.2″ but above 0.0″, the fan state is changed to third state 204. Additionally, if DP1 is determined to be below a predetermined level, such as, for example, 0.0″ such that a negative pressure is achieved, the fan state is changed to check filter state 210.

In fifth state 212, the main is in an on mode, fan 66 is in an on state at a medium-high speed, and a time delay is initiated for a predetermined amount of time. When DP1 is determined to be above a predetermined level, such as, for example, 0.4″, the fan state is changed to sixth state 214. However, at fifth state 212, if DP1 is determined to be below a predetermined level, such as, for example, 0.2″ but above 0.0″, the fan state is changed to fourth state 208. Additionally, if DP1 is determined to be below a predetermined level, such as, for example, 0.0″ such that a negative pressure is achieved, the fan state is changed to check filter state 210.

In sixth state 214, the main is in an on mode, fan 66 is in an on state at a high speed, and a time delay is initiated for a predetermined amount of time. When DP1 is determined to be below a predetermined level, such as, for example, 0.2″ but above 0.0″, the fan state is changed to third state 204. Additionally, if DP11 is determined to be below a predetermined level, such as, for example, −0.2″ such that a negative pressure is achieved, the fan state is changed to check filter state 210.

In check filter state 210, an efficiency level or a contamination level of filter elements is determined. A time delay is initiated to be sure that effects from the main are eliminated. DP1 is determined using sensors to determine the pressure difference through air quality device 10 as a whole. A second differential pressure DP2 is measured to determine a pressure difference through a particular filter element, such as, for example, particle filter element 68 (shown in FIG. 1). DP1 and DP2 are evaluated and compared to determine an amount of pressure differential attributable to the filter element. At a predetermined threshold, a filter change indication may be transmitted to user interface 124 (shown in FIG. 4). After a time delay, if DP1 is determined to be above a predetermined level, such as, for example, −0.1″, the fan state is changed to sixth state 214. However, at check filter state 210, if DP1 is determined to be below a predetermined level, such as, for example, −0.1″, the fan state is changed to first state 202.

In one embodiment, the various components of air quality device 10 may be operated based on the particular fan state. For example, anti-microbial module 54, and more particularly, ultraviolet lamps 78, may be operated when fan 66 is in second, third, fourth, fifth or sixth states, but is off when fan is in first state. Additionally, humidity control module 56 may be operated when fan 66 is in second, third, fourth, fifth or sixth states, but is not operated when fan is in first state. Additional criteria may apply to the operation of humidity control module 56. For example, humidity control module 56 operation may also be based upon a temperature of the air, a set-point by a user or a pre-programmed set-point, or a humidity level sensed by a humidity sensor at a remote location.

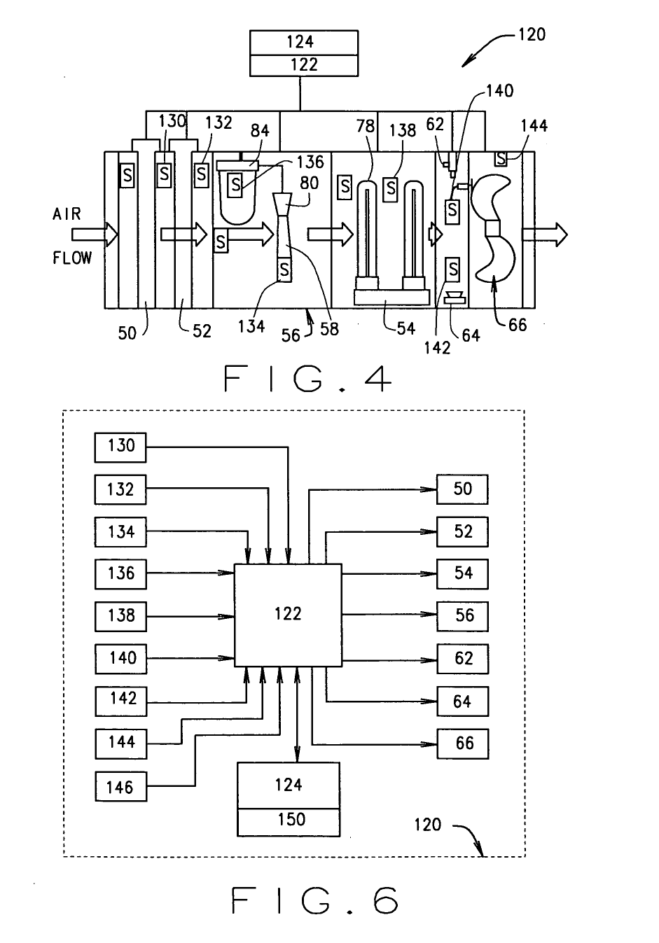

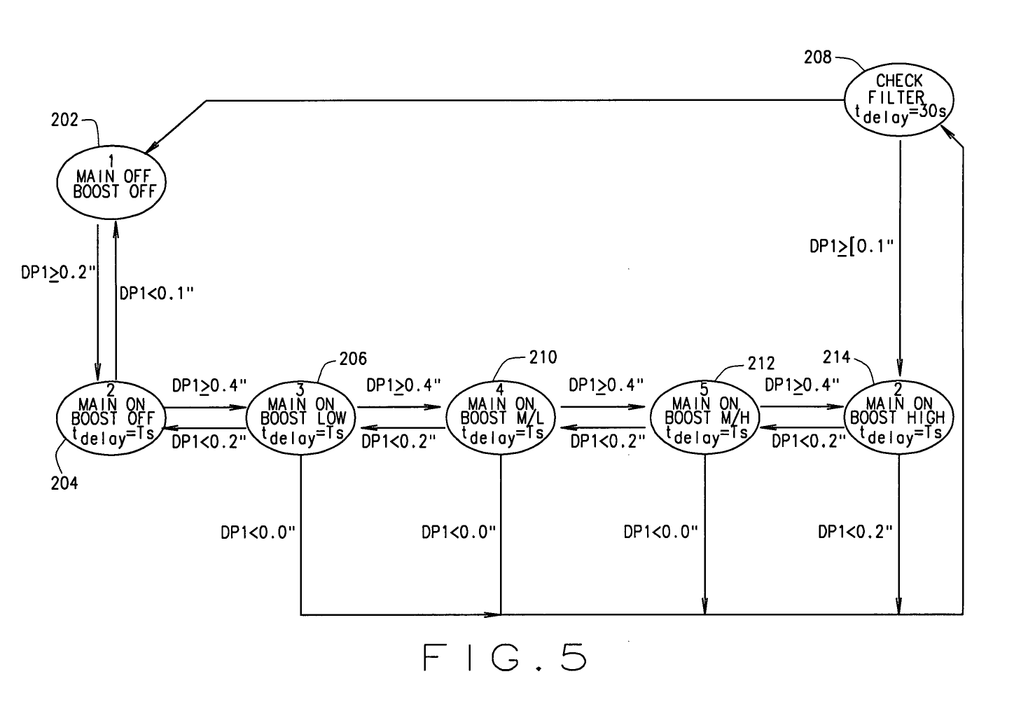

FIG. 6 is a schematic view of monitoring and control system 120 for air quality device 10 (shown in FIG. 1). Monitoring and control system 120 includes controller 122, such as a microprocessor or a microcomputer, and user interface 124. In one embodiment, user interface 124 includes a display 150 for displaying information relating to the operational status of the various components of air quality device 10 and/or information relating to the status of the airflow channeled through air quality device 10. Additionally, user interface 124 receives control commands from the user to transmit to controller 136, such as through a touch screen or a keypad. In one embodiment, controller 122 may be controlled at a remote interface via a wired or wireless connection.

In the exemplary embodiment, controller 122 receives inputs from user interface 124 and sensors 130, 132, 134, 136, 138, 140, 142, and 144. The signals from user interface 124 generally relate to operational characteristics of air quality device 10, such as, for example, the working status of the various components of air quality device 10. The signals from sensors 130, 132, 134, 136, 138, 140, 142, and 144 generally relate to functional characteristics of air quality device 10, such as, for example, the quality of the airflow through air quality device 10, the amount of airflow through air quality device 10, the replacement status of the various components in air quality device 10, and the like. In one embodiment, controller 122 also receives signals from remote sensors 146, such as sensors located in a room of the house or building. Sensors 146 may monitor the air quality or conditions in the room, such as, for example, a humidity level, a temperature, or a contaminant level of the air.

Additionally, particle removal module 50, odor removal module 52, anti-microbial module 54, humidity control module 56, fragrance injector module 62, ozone generation module 64, and fan 66 are operatively coupled to controller 122. Accordingly, the operation of the various components of air quality device 10 are controlled from a single source, namely controller 136, based on signals received from user interface 124 and/or sensors 130, 132, 134, 136, 138, 140, 142, and 144.

Controller 122 controls the operation of the various components of air quality device 10. For example, controller 122 controls the operation of humidity control module 56. In one embodiment, a user selects a desired level of humidity at user interface 124, or controller selects a predetermined humidity level based on other inputs such as the temperature or other air quality inputs. During operation, the humidity level is monitored by water supply system sensor 134. For example, the humidity level may be monitored within housing 12 (shown in FIG. 1), within a duct either upstream or downstream of air quality device 10, or at a remote location such as within a room or window of the house or building. When the humidity level is above a predetermined amount, humidity control module 56 may be deactivated. When the humidity level is below a predetermined amount, humidity control module 56 may be activated. Additionally, controller 122 may send a signal to display 150 relating to an operation status of humidity control module 56, such as, for example, the humidity level.

Controller 122 may control water supply system 80, such as, for example, by controlling an amount of water supplied to the humidifying media. For example, the supply may be time based or volume based, and the supply may be continuous or pulsed based on control algorithms. Additionally, the supply may be based on the temperature of the airflow, the airflow rate through humidity control module 56, and/or the amount of water sensed in either the airflow or the humidifying media. For example, in one embodiment, a conductivity sensor is provided to determine if water is present in the humidifying media, such as, for example, at the lower portion of the humidifying media, or alternatively, within drain pans 86. The pulse rate or duration may be controlled based upon the wetness of the media or the presence of water in drain pans 86. Additionally, controller 122 may send a signal to display 150 relating to an operation status of water supply system 80, such as, for example, a media filter replacement. Controller 122 may control water filtration system 84, such as, for example, by controlling the recirculation tank or a flushing of the recirculation tank or the humidifying media. Controller 122 may send a signal to display 150 relating to an operation status of water filtration system 84, such as, for example, a filter change based on a pressure drop, an amount of flow, or a passage of time.

Controller 122 also controls the operation of particle removal module 50. In one embodiment, a user selects operating characteristics, such as, for example, an acceptable level of contaminants, at user interface 124, or controller 122 selects an acceptable level of contaminants based on other inputs. During operation, the operational status of particle removal module 50, such as, for example, a level of clogging is monitored by particle removal module sensor 130 based on inputs such as pressure feedback, airflow feedback, or elapsed time. Additionally, an amount of contaminants in the airflow may be monitored by particle removal module sensor 130. Controller 122 may send a signal to display 150 relating to an operation status of particle removal module 50, such as, for example, a filter element replacement.

Controller 122 controls the operation of odor removal module 52. In one embodiment, a user selects operating characteristics, such as, for example, an acceptable level of odors, at user interface 124, or controller 122 selects an acceptable level of odors based on other inputs. During operation, the operational status of odor removal module 52, such as, for example, a level of clogging or an amount of active product remaining is monitored by odor removal module sensor 132. Additionally, an amount of contaminants in the airflow may be monitored by odor removal module sensor 132. Controller 122 may send a signal to display 150 relating to an operation status of odor removal module 52, such as, for example, a filter element replacement.

Controller 122 also controls the operation of anti-microbial module 54. In one embodiment, a user selects operating characteristics, such as, for example, an acceptable level of microbes, at user interface 124, or controller 122 selects an acceptable level of microbes based on other inputs. During operation, the operational status of anti-microbial module 54, such as, for example, an ultraviolet light level or efficiency is monitored by anti-microbial module sensor 134. Additionally, an amount of contaminants in the airflow may be monitored by anti-microbial module sensor 134. Controller 122 may send a signal to display 150 relating to an operation status of anti-microbial module 54, such as, for example, a lamp replacement.

Controller 122 controls the operation of fan 66. In one embodiment, a user selects operating characteristics, such as, for example, an operating speed or an operating time, at user interface 124, or controller 122 selects an acceptable mode of operation based on other inputs. During operation, the amount of airflow through air quality device 10 is determined. When the amount of airflow is below a predetermined amount, controller 122 operates fan 66. The operational status and or operational speed may be controlled based on pressure feedback, airflow volume feedback, DC current feedback such as by use of a fan tachometer, or AC current feedback. Controller 122 may send a signal to display 150 relating to an operation status of fan 66.

A multi-function, integrated air quality device is thus provided which improves the air quality and comfort level of a home or building in a cost effective and reliable manner. The air quality device improves the air quality by various treatment functions such as, purification, humidification, microbe reduction, odor removal, fragrance enhancement, temperature adjustment, air flow management, and the like. Specifically, the air quality device includes the functions of a in a single unit. Additionally, the multiple functions of the air quality device are controlled using a single source, namely a controller. In the exemplary embodiment, the air quality device includes a particle removal module, an odor removal module, an anti-microbial module, a humidity control module, a fragrance injector module, and an ozone generation module. Each of the modules are operative coupled to the controller. Additionally, the air quality device includes a plurality of sensors for determining the operation status of each of the modules. Specifically, the sensors determine the amount or quality of airflow channeled through the air quality device. Signals relating to such are transmitted to the controller. Additionally, the signals are transmitted to a display such that a user can interface with the air quality device. Accordingly, the air quality device, and all aspects of the air quality, are operated and monitored from a single source. As a result, the air quality device operates in a cost effective and reliable manner. The air quality device is cost effective in that the total number of air filtering components is reduced and the air quality device can operate in a cost effective manner by providing feedback relating to the operation status of each of the various components. Additionally, the total amount of space occupied by the air quality device is reduced as each of the various components of the air quality device are integrated into a single unit. Moreover, the air quality device is easier to use due to the integration of the various components into a single unit.

Exemplary embodiments of air quality devices are described above in detail. The air quality devices are not limited to the specific embodiments described herein, but rather, components of each air quality device may be utilized independently and separately from other components described herein. For example, each air quality device component can also be used in combination with other air quality devices components.

While the invention has been described in terms of various specific embodiments, those skilled in the art will recognize that the invention can be practiced with modification within the spirit and scope of the claims.

What is claimed is:

1. An air quality device comprising:
a housing defining an airflow path;
a humidity control module in flow communication with the airflow path; and
an air contaminant removal module in flow communication with the airflow path comprising at least one of:
a particle removal module arranged within said housing;
an odor removal module arranged within said housing; and
an anti-microbial module arranged within said housing.

2. An air quality device in accordance with claim 1 wherein said air contaminant removal module comprises:
a particle removal module configured to remove particulates from the airflow channeled through said housing, said particle removal module comprising at least one of a media filter element, a charged media filter element, an electrostatic cell element, an impingement filter element, and a particle ionization element;
an odor removal module configured to remove odors from the airflow channeled through said housing, said odor removal module comprising at least one of an activated carbon media filter element, an activated alumina element, an ozone generating element, a hydroxyl radical generating element, an absorption filter element, a photo-catalyst element, and a chemical catalyst element; and
an anti-microbial module configured to remove at least one of bacteria, viruses and microbes from the airflow channeled through said housing, said anti-microbial module comprising at least one of an ultra-violet lamp element, an ozone element, and an ionization element.

3. An air quality device in accordance with claim 1 wherein each of said air contaminant removal modules and said humidity control module are oriented in series within said housing, such that said humidity control module is positioned downstream of each of said air contaminant removal modules.

4. An air quality device in accordance with claim 1 wherein said airflow path is divided into a first airflow path and a second airflow path, said first airflow path directed to said air contaminant removal module, said second airflow path directed to said humidity control module.

5. An air quality device in accordance with claim 1 wherein said housing comprises an expanded area portion having an expanded cross-section, one of said humidity control module and said air contaminant removal module positioned within said expanded area portion, such that a resonance time for the airflow through said expanded area portion is increased.

6. An air quality device in accordance with claim 1 wherein said humidity control module comprises a humidifying media element, said humidifying media element coupled within said housing and having one of a vertical orientation, a horizontal orientation, and an inclined orientation.

7. An air quality device in accordance with claim 1 wherein said humidity control module comprises a water supply element, said water supply element comprising one of a water distribution tray and a water spray nozzle.

8. An air quality device in accordance with claim 7 wherein said water supply element is configured to supply water to said humidity control module, the supply of water is pulsed based upon a control algorithm based upon at least one of time, air temperature, media wetness, and air wetness.

9. An air quality device comprising:
a housing defining an airflow path;
a humidity control module in flow communication with the airflow path;
an air contaminant removal module in flow communication with the airflow path, wherein said air contaminant removal module comprises at least one of:
a particle removal module arranged within said housing;
an odor removal module arranged within said housing; and
an anti-microbial module arranged within said housing; and
a controller operatively coupled to each of said air containment removal modules and said humidity control module.

10. An air quality device in accordance with claim 9 further comprising at least one sensor configured to detect at least one of the operational status of said modules and the status of the airflow through said housing, wherein said sensor is configured to transmit a signal to said controller based on the status detected by said sensor.

11. An air quality device in accordance with claim 9 further comprising a plurality of pressure sensors arranged within said housing and coupled to said controller, said pressure sensors transmit a signal to said controller based on the pressure of the airflow through said housing.

12. An air quality device in accordance with claim 9 further comprising at least one humidity sensor arranged within said housing and coupled to said controller, each said humidity sensor transmits a signal to said controller based on the humidity of the airflow through said housing.

13. An air quality device in accordance with claim 9 wherein said air contaminant removal module comprises an anti-microbial module comprising an ultraviolet lamp element, said air quality device further comprising an ultraviolet light sensor arranged within said housing and coupled to said controller, said ultraviolet light sensor transmits a signal to said controller based on an amount of ultraviolet light sensed by said ultraviolet light sensor.

14. An air quality device in accordance with claim 9 further comprising at least one sensor configured to detect at least one of the operational status of said modules and the status of the airflow through said housing, wherein said sensor is positioned within said housing.

15. An air quality device in accordance with claim 9 further comprising at least one sensor configured to detect at least one of the operational status of said modules and the status of the airflow through said housing, wherein said sensor is positioned remote with respect to said housing.

16. An air quality device in accordance with claim 9 wherein said controller is configured to operate said humidity control module and each of said air contaminant removal modules independently with respect to one another.

17. An air quality device in accordance with claim 9 further comprising a display coupled to said controller, said display configured to at least one of display information relating to the operational status of said modules, display information relating to the status of the airflow through said housing, and receive control commands to transmit to said controller.

18. An air quality device comprising:
a housing defining an airflow path;
a humidity control module in flow communication with the airflow path;
an air contaminant removal module in flow communication with the airflow path, wherein said air contaminant removal module comprises at least one of:
a particle removal module arranged within said housing;
an odor removal module arranged within said housing; and
an anti-microbial module arranged within said housing;
an air moving device coupled in flow communication with the airflow path; and
a controller operatively coupled to each of said air containment removal modules, said humidity control module, and said air moving device.

19. An air quality device in accordance with claim 18 further comprising a sensor arranged within said housing and coupled to said controller, said sensor configured to transmit a signal to said controller based on one of an amount of airflow through said housing and a pressure of the airflow through said housing, said controller configured to operate said air moving device based on the signal from said sensor.

20. An air quality device in accordance with claim 18 wherein said air moving device is configured to increase one of a flow rate of airflow through said housing and a pressure of airflow exhausted from said housing.

21. An air quality device in accordance with claim 18 wherein said housing comprises an inlet and an outlet, said air moving device coupled to one of said inlet and said outlet.

22. A method of purifying air comprising:
providing a humidity control module;
providing an air containment removal module comprising at least one of a particle removal module, an odor removal module, and an anti-microbial module;
channeling airflow through the humidity control module; and
channeling airflow through air containment removal module.

23. A method of purifying air in accordance with claim 22 further comprising channeling airflow through air containment removal module prior to channeling the airflow through the humidity control module.

24. A method of purifying air in accordance with claim 22 further comprising:
providing a controller; and
operating at least one of the humidity control module and the air containment removal module based on at least one of the operational status of the humidity control module and the air containment removal module and the status of the airflow through the humidity control module and the air containment removal module.

25. A method of purifying air in accordance with claim 24 further comprising:
coupling a sensor to the controller; and
detecting at least one of the operational status of the humidity control module and the air containment removal module and the status of the airflow through the humidity control module and the air containment removal module.

26. A method of purifying air in accordance with claim 22 further comprising:
providing an air moving device; and
operating the air moving device to channel airflow through the humidity control module and the air containment removal module.

27. A method of purifying air in accordance with claim 26 further comprising:
providing a sensor configured to detect at least one of the operational status of the humidity control module and the air containment removal module and the status of the airflow through the humidity control module and the air containment removal module;
coupling the sensor to a controller;
coupling the air moving device to the controller; and
operating the air moving device based on an input to the controller from the sensor.
